(19) United States
(12) Patent Application Publication
(10) Pub. No.: US 2013/0332267 A1
(43) Pub. Date: Dec. 12, 2013

(54) SELECTING CONTENT BASED ON DATA ANALYSIS

(71) Applicants: Momchil Filev, Mountain View, CA (US); Julián Genoud, Ciudad de Buenos Aires (AR)

(72) Inventors: Momchil Filev, Mountain View, CA (US); Julián Genoud, Ciudad de Buenos Aires (AR)

(73) Assignee: GOOGLE INC., Mountain View, CA (US)

(21) Appl. No.: 13/490,221

(22) Filed: Jun. 6, 2012

(51) Int. Cl. G06Q 30/02

(52) U.S. Cl. 705/14.46

(57) ABSTRACT

Apparatus and method for selecting at least one content item based on data analysis. In accordance with some embodiments, a plurality of linked web pages of a website are defined by a publisher. Each web page has a respective layout which includes associated content and at least one slot adapted to receive a content item. A total number of web pages visited by each device of the website during an associated device session in which the device requests display of one or more of the web pages on a network accessible device is accumulated. At least one content item is transferred for display on the device during each said device session. A revenue amount is identified to the publisher from said displayed content items for each different total number of web pages visited during said device sessions.

### BACKGROUND

Content providers generally operate to provide content for display on web pages of Internet websites. The content may take a variety of forms, and may be updated on a regular basis to attract and retain user and/or device visits to the site.

While operative, there remains a continual need for improvements whereby user enjoyment of a particular web page, and in at least some cases, opportunity for revenue for the proprietor of a website, may be enhanced.

### SUMMARY

Various embodiments disclosed herein are generally directed to selecting an advertisement to maximize ad revenue to a publisher.

In accordance with some embodiments, a plurality of linked web pages of a website are identified by a publisher. Each web page has a respective layout which includes associated content and at least one slot adapted to receive a content item. A total number of web pages visited by each device of the website during an associated device session in which the device requests display of one or more of the web pages on a network accessible device is determined. At least one content item is transferred for display on the device during each said device session. A revenue amount is identified to the publisher from said displayed content items for each different total number of web pages visited during said device sessions.

These and other features and advantages which may characterize various embodiments can be understood in view of the following detailed discussion and the accompanying drawings.

### BRIEF DESCRIPTION OF THE DRAWINGS

FIG. 1 provides a functional block representation of a network based system in accordance with various embodiments.

FIG. 2 shows aspects of the system of FIG. 1 in accordance with some embodiments.

FIG. 3 provides an example web page layout that may be displayed on the network user device in FIG. 2.

FIG. 4 illustrates multiple available web pages on a publisher's website through which a user may navigate.

FIG. 5 is a table identifying an example revenue amount to a publisher based on multiple web page visits by users.

FIG. 6 is a schematic depiction of steps carried out in accordance with some embodiments.

FIG. 7 is a flow chart for a routine illustrative of steps that may be carried out in accordance with various embodiments.

### DETAILED DESCRIPTION

The present disclosure generally relates to the management of content, and more particularly, for selecting content to display based upon data analysis.

It is becoming increasingly common to display content within the context of an Internet web page. The content may take a variety of forms, and be supplied from a variety of different content providers. One form of content may be in the form of advertisements (ads) that are displayed within the context of an Internet web page. Configuring a web page to display such items may lead to increased revenue opportunities for the publisher of the web page. Contextual content systems can provide an efficient mechanism for displaying relevant ads on third party publisher's websites. When a user of a web browser selects a particular web page affiliated with the advertising system, the webpage sends a notification to the ad server, which in turn selects one or more appropriate ads for display on the requested webpage of the publisher. The selection may use contextual signals based on information associated with the publisher, as well as user profile information collected by the publisher or other third parties relating to the demographics and historical behavior of the user. An auction may be carried out where multiple candidate ads are sorted and the most relevant ads are selected for display on the publisher's web page.

Some content includes a creative portion which may involve text, graphics, images or video files associated with an advertised service and/or product, or other invitation to action by the user. Some content may further include an interactive portion such that user selection (a “click”) of the content will direct the user to additional information related to the content. The interactive portion of content can take a variety of forms. For example, advertisements can be configured such that, upon selection, the user is connected to a linked web page with additional information, often referred to as a “landing page.” Some advertisements may have forms or fields to “pre-load” searches or other operations on the landing page associated with the ad.

Other content may have a “click to call” feature that enables a user to call (establish a telephonic connection with) the advertiser directly from the ad, via clicking on a virtual button. Still other advertisements may have a “click to chat” feature that opens a chat window directly from a virtual link or button on the advertisement which enables the user to chat with a representative associated with the ad.

A “click to buy” (or “click to purchase”) feature allows users to carry out a purchase transaction for an advertised product or service. Similarly, a “click to download” feature can initiate a transaction that takes the user to an application store to purchase an advertised application (app).

An ad server can maintain history information to help the publisher gage the effectiveness of the website and/or a particular ad campaign. A publisher may wish to modify the website in view of this history information, such as in an effort to maximize ad revenue paid to the publisher.

Some common metrics reportable to a publisher by an ad server may include page views (PVs), clicks (selections of ads), page CTR (click through rate—number of times an ad is selected v. number of times the ad is viewed), CPC (cost per thousand views), and page RPM (revenue per thousand impressions). The overall website revenue may also be compared to total numbers of visitors to a website. While operable, these and other existing metrics may not fully indicate the effectiveness of an existing website layout, and may drive less than optimum behavior by the publisher in modifying the website.

Various embodiments of the disclosed subject matter are characterized as being generally directed to improving the targeting of content, such as ads in a contextual advertising system. As discussed in greater detail below, in some embodiments statistics are maintained by users of a website in terms of total number of web pages visited during each user session. An analysis engine determines an amount of revenue provided to the publisher from displayed advertisements on the web pages for each different total number of web pages visited during said user sessions. In this way, the publisher can take steps to modify the website to enhance revenue from, and user enjoyment of, the website.

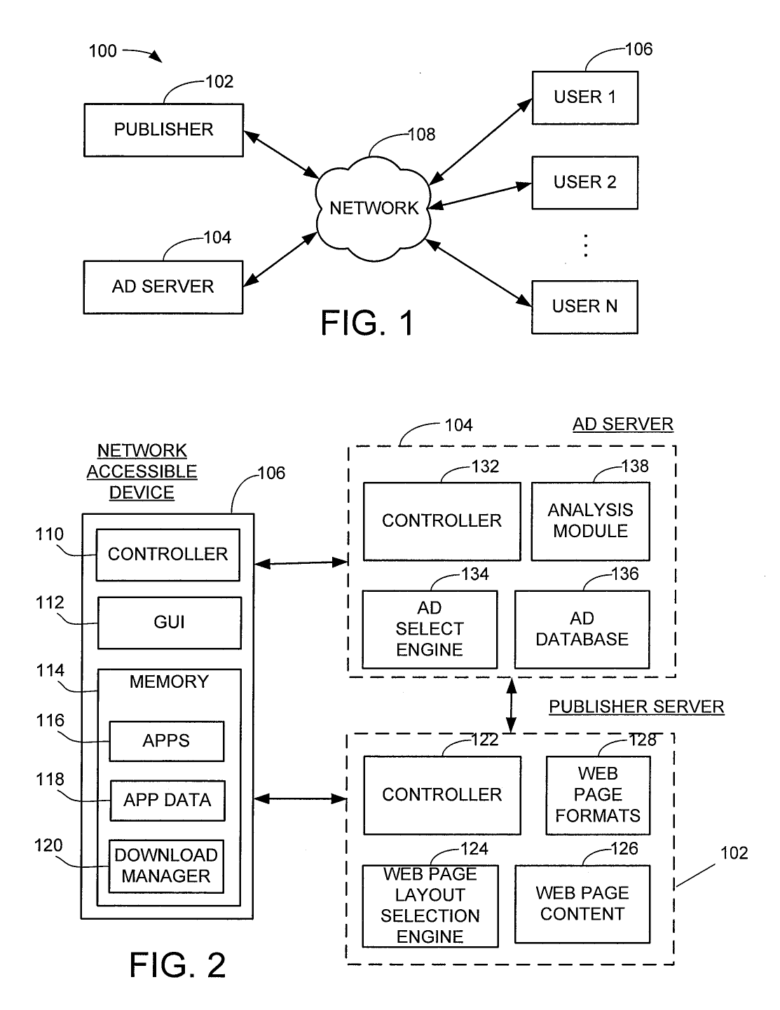

These and other features and benefits can be understood beginning with a review of FIG. 1 which depicts a network based, dynamic content transfer system 100 constructed and operated in accordance with various embodiments. The system incorporates a number of active elements including a publisher server 102, an advertisement (ad) server 104, and a number N of user devices 106, all of which communicate over one or more networks 108.

The publisher server 102 may represent a web page hosting server or similar system adapted to display one or more web pages from a website of a publisher (e.g., source of the website). The ad server 104 services ad requests to display ads in conjunction with the web pages. While the respective publisher and ad servers 102 and 104 are shown as separate modules, it will be appreciated that these functions can be readily combined; for example, the publisher server operation can be incorporated into the ad server, etc.

The user devices 106 represent individual network accessible devices, such as desktop computers, laptop computers, smart phones, tablets, gaming consoles, televisions, and similar devices adapted to interact with the publisher and ad servers 102 and 104, respectively.

The network 108 can take any suitable form(s) such as a wide area network (WAN), a local area network (LAN), a broadband wireless network, etc. It will be appreciated that other elements may be incorporated into the system 100 as desired.

FIG. 2 shows aspects of the system 100 of FIG. 1 in accordance with some embodiments. A selected network accessible (user) device 106 from FIG. 1 is contemplated as comprising a desktop computer (personal computer, PC) with a high speed Internet connection to communicate with the network 108. This is merely for purposes of providing a concrete example and is not limiting.

The user device 106 includes a controller 110, a graphical user interface (GUI) 112 and memory 114. The controller 110 may be a programmable processor that uses associated operating system programming and application software (e.g., a web browser) in the memory to interact with the network 108. The GUI 112 may include a display monitor, keyboard, mouse, etc. The memory 114 may represent a hierarchical memory structure made up of various memory devices within the user device 106 including such elements as a non-volatile main memory (e.g., disc memory, solid-state drive, etc.), data transfer buffer, local processor (L1-L3) cache, etc. The memory 114 stores various operational modules including applications (apps) 116, application (app) data 118, and a download manager 120.

Various ways in which web page data can be transferred for display on the GUI 112 will be discussed in greater detail below. At this point, it will be understood that the user of the device 106 opens the web browser application and requests a selected web page from the publisher. A controller 122 of the publisher server 102 processes the request using various operational modules including web page layout selection engine 124, web page content storage 126, and web page format data 128.

The selected web page may include one or more ad slots, which are serviced under the direction of a controller 132 of the ad server 104 in conjunction with an ad selection engine 134, an ad database 136, and an analysis module 138. The ad selection engine 134 may carry out an ad auction or other selection methodology to select and transfer an ad for each ad slot in the requested web page.

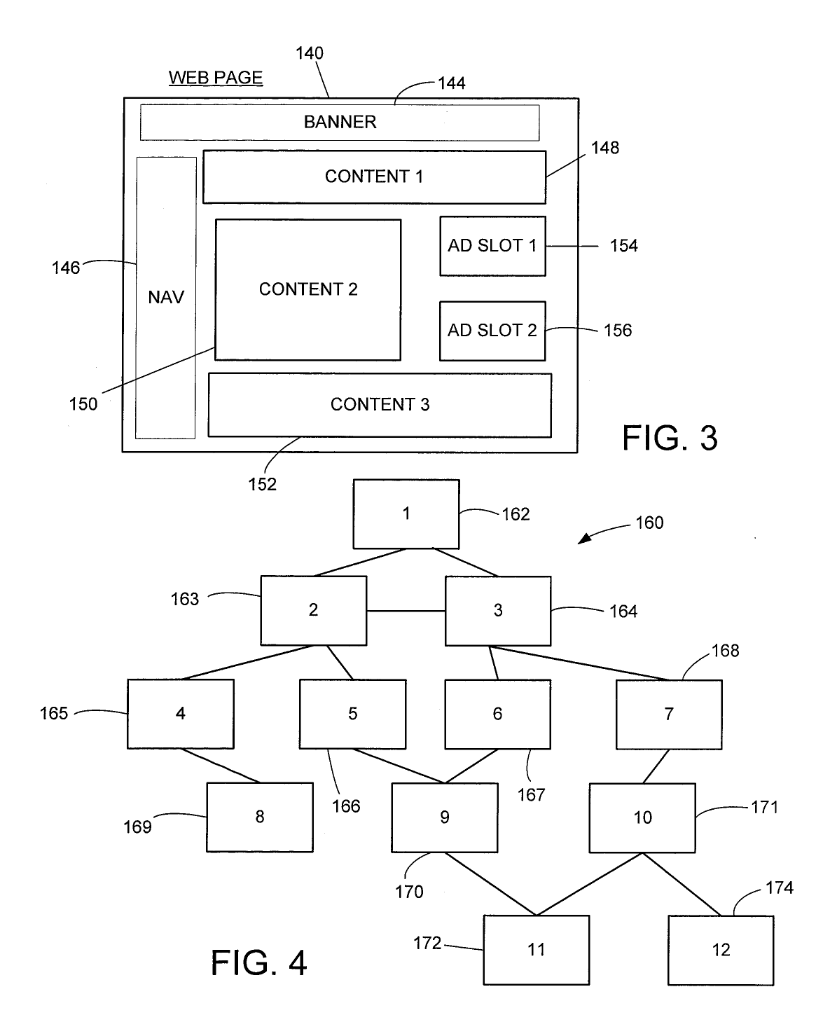

FIG. 3 illustrates a layout 140 for the web page requested in FIG. 2. The layout 140 includes a number of elements (objects), including a banner slot 144, a navigation (nav) bar 146, and three content areas 148, 150 and 152 (respectively identified as “Content 1” through “Content 3”). It is contemplated albeit not required that the banner provides heading information for the web page (e.g., name of the website, identification of the publisher, etc.), the navigation bar provides links to allow navigation within the page, to other pages, and/or to other websites; and the content areas provide publisher content (e.g., images, video links, text, etc.).

The layout 140 further includes ad slots 154 (“Ad Slot 1”) and 156 (“Ad Slot 2”). The respective locations of the ad slot are different. It will be noted that the layout 140 has different total numbers of ads, as well as different locations for the ads and different locations for the content. Other layout variations are readily contemplated, including a sequence that provides at least one or more possible layouts for the web page.

Referring to FIG. 4, by way of example, a publisher defines a plurality of linked web pages (1-12) 162-173 of a website 160 of the publisher through which the user may navigate as desired. It should be understood that although twelve (12) web pages are shown herein, any number (N) of web pages may be provided in the publisher's website. The pages may be linked via hyperlinks or other mechanisms that enable the user to move from one web page to the next as indicated. Each time a user selects a new webpage on the publisher's site, a notification is sent to the ad server 104.

The analysis module 138 in FIG. 2 determines the total number of pages visited during each website session, and segments the sessions by the number of pages visited. For example, if a user only visits one page, such as home page 162 (Page 1), the session will be recorded under a 1-page visit segment. If the user visits web page 162 and web page 163 (Page 2), the session will be recorded in a 2-page visit segment, and so on.

The analysis module 138 can track the total number of visited web pages by monitoring the number of requests for ads, or through other contextual signals supplied by the system. In some embodiments, page visit segments are identified irrespective of the actual pages visited; for example, sessions involving five page views are grouped together regardless which five pages are actually viewed. In other embodiments, specific combinations of web page views are tracked; for example sessions involving Pages 1, 3, 6 and 9 are grouped together, etc.

The analysis module 138 further operates to track revenue to the publisher per session, and correlates this to the session segments. A revenue amount may be identified to the publisher from any displayed advertisements for each different total number of web pages visited during the user sessions.

FIG. 5 shows a table with various metrics that may be provided to a publisher based on various user web page visits in accordance with some embodiments. Other formats and metrics may be provided as desired. The following metrics can enable publishers to evaluate their performance: Page views, Clicks, Page CTR, CPC, and Page RPM. Publishers often focus on Page RPM (or CPM) and CTR as the ultimate metrics to optimize for. However, emphasizing CPM and CTR performance can be misleading and may cause a publisher to arrive at the wrong conclusions.

In the display table of FIG. 5, sessions are segmented into “1-page Visits”, “2-page Visits”, 3-page Visits“, etc. If one only observes CTR (Clicks/Page views) one would see that users who visit just one page (under the “1-page Visits” segment) have higher CTR (15.05%), while for the rest of the users' CTR is less than 9.3%. Visits with a one page view are registered in Analytics as Bounces. Thus, if the publisher only looks at the CTR metric, the publisher might be motivated to set up the website to foster more bounces by serving very aggressive ads on the home page. However, when one considers revenue per 1,000 visits (analogous to CPM but in terms of Visits/Users rather than PVs), then the 1-page visitors bring the least amount of revenue ($14.33), while visits that navigate throughout the site (2, 3, . . . , 9+ pages) yield much more revenue for the publisher.

Focusing on a relatively higher CTR rate for 1-page visits may lead the publisher to conclude that a lot of visitors only view a single page of the website before moving on. The publisher may therefore redesign the website to maximize one-page views through more aggressive ad placement and larger numbers of ads on the first page.

However, additionally tracking revenue per visitor (RPV) values as described herein on the same scale—that is, for 1-page visits, 2-page visits, . . . up to N-page visits, may tend to show that more total revenue is obtained for visitors that linger and click on multiple pages. Thus, instead of modifying the website to encourage bounces, providing data on a total webpage visit basis as set forth in FIG. 5 may lead the publisher to redesign the website to use a less aggressive home page format and encourage the visitor to linger longer and click through more web pages.

The data in FIG. 5 can be determined in a variety of ways. In some embodiments, a cookie is generated in a server memory to identify the user for each web page that is served with ads. The cookie is generated in response to a request to transfer the ad for display of a first web page. The cookie is accessed for each subsequent transfer of an ad for a different web page visited during the user session. Thus, revenue may be determined based on an individual user basis.

In some embodiments, an opt in/opt out feature is incorporated into the system so that, responsive to an expressed desire on the part of a user, profile information is accumulated and stored by the publisher as a result of previous dealings of the user with the publisher site. For example, if the user is a registered user of the publisher's website, certain non-personally identifiable information, such as gender, age, interests, etc., may be voluntarily supplied by the user at the time of the registration and forwarded for use in selecting the appropriate web page layout. Other profile information may include information supplied by the device, and/or supplied by the ad server, such as previous links visited by the user prior to requesting the current web page, cookies previously stored on the device, purchase history information associated with the device, etc. Data anonymity is provided for security and privacy reasons.

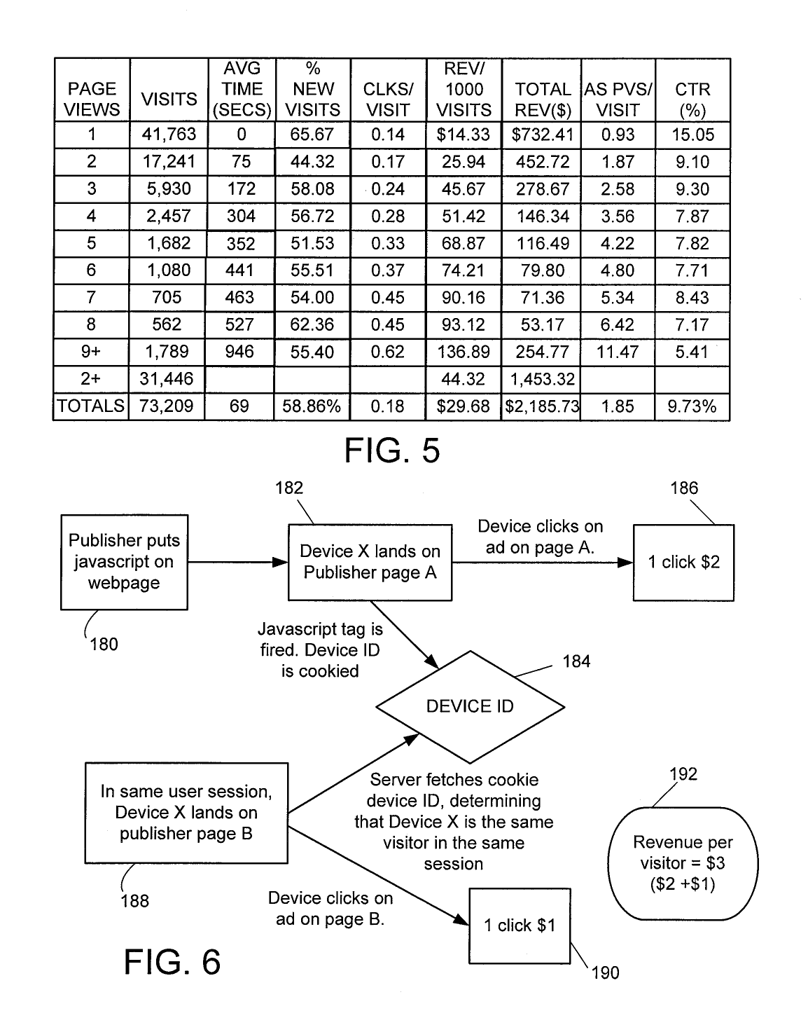

FIG. 6 shows a sequence that may be carried out in accordance with some embodiments. As indicated by block 180, a publisher places a javascript tag on the publisher's webpage. Device X lands on publisher web page A at 182. The javascript tag is fired and a cookie is generated for device X's identification at 184, provided that device X has enabled cookies. In some cases, the cookies may be anonymized, or other mechanisms may be set in place to allow a user to control privacy settings. A user of device X clicks on an advertisement on web page A and a revenue amount is determined as indicated by block 186 (in this case, $2 in revenue responsive to the click).

In the same user session, device X subsequently lands on publisher's web page B, as indicated by block 188. The server fetches the cookie and determines that device X is the same visitor in the same session. The user of device X clicks on an ad on page B and a revenue amount is determined as indicated by block 190 (in this case, $1 in revenue). Block 192 indicates the total amount of revenue determined in device X's session visiting both web pages A and B (e.g., $2+1=$3).

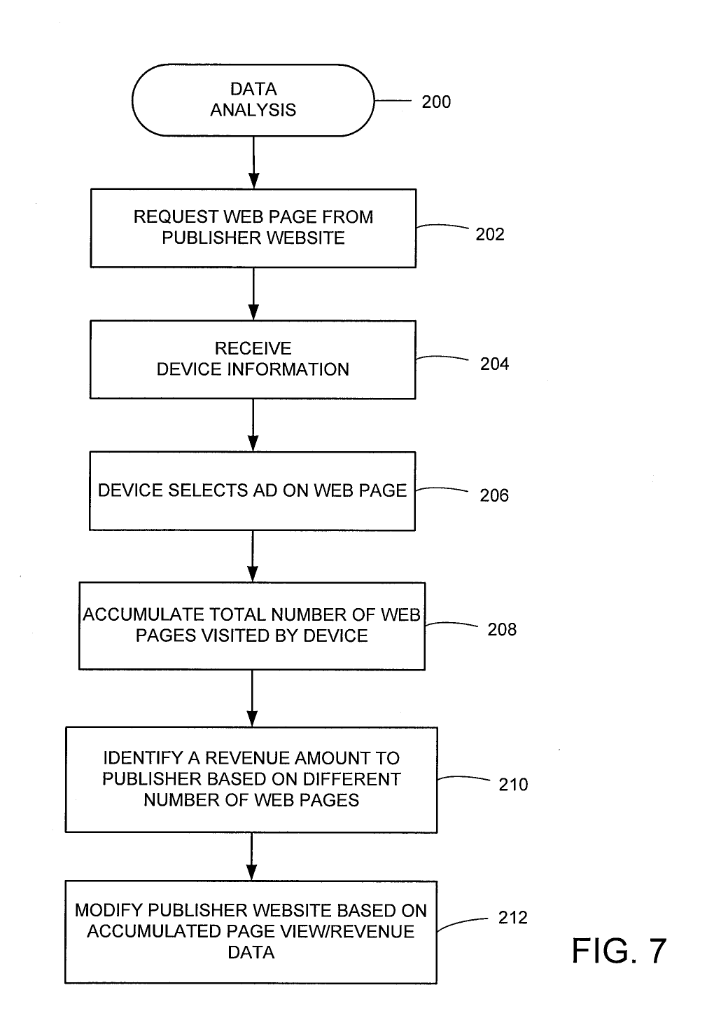

FIG. 7 provides a flow chart for data analysis routine 200, generally illustrative of steps that may be carried out in accordance with one embodiment of the foregoing discussion. A request for a web page from a publisher website is issued at step 202. As discussed above, this can be carried out by the user of the network accessible device 106 opening a web browser or other application and issuing an appropriate URL or other data exchange operation to request the page. User information is obtained at step 204. The user information may take any number of forms, including, but not limited to demographic or history information associated with the network accessible device 106 that the user has volunteered or the system has accumulated in such a way as to be non-personally identifiable information. In some embodiments, an opt in/opt out feature is incorporated into the system as discussed herein. Data anonymity is provided for security and privacy reasons. It is contemplated that the requested web page includes at least one ad slot, so that the ad server operates during steps 202, 204 as discussed above to select and transfer an ad for display in each ad slot as the web page is loading on the user's device.

Once loaded, the device navigates the web page and selects an ad at step 206. It will be noted that this is merely illustrative, as it is not necessary that the device select any ads during the session in order for the analysis engine to perform the segment revenue analyses discussed above. The ad server 104 accumulates the total number of web pages visited by the device during the session at step 208. This can also be carried out as discussed above and may include the generation of a session cookie which tracks the total number of web pages responsive to ad requests for each page.

At step 210, the analysis module 138 of the ad server 104 identifies a revenue amount based on accumulated number of web pages visited by devices and various metrics to the publisher. The analysis engine 138 initializes a counter value responsive to the transfer of the selected advertisement. The counter value is incremented responsive to each additional web page of the website visited by the device during a contiguous device session for which at least one additional advertisement is transferred by the ad selection engine 134. The analysis engine 138 is further adapted to determine a total amount of revenue to the publisher from the displayed advertisements for each different total accumulated count of web pages during the respective device sessions.

The analysis engine 138 generates a table on a graphical user interface that lists total revenue to the publisher for each of a plurality of session lengths having total number of accumulated web pages from 1 to N, where N is a total number of available web pages in the web site having at least one ad slot.

At step 212, as desired the publisher modifies the layout of at least one of the web pages of the website in relation to the revenue obtained by the publisher and the total accumulated count of web pages in at least one of the device sessions.

While various embodiments discussed herein have been in the context of a desktop PC running an Internet web browser, it will be appreciated that such is merely for purposes of providing a concrete illustration and is not limiting. Any number of different types and styles of devices can be used. For example, the ads can be provided in the context of non-web browser applications so that the format and layout of the publisher supplied content are altered as set forth herein. The revenue data may be further segmented as required, such as by time period (e.g., past 30 days, etc.), by geographic region, by demographic data, etc. In some embodiments, the publisher may elect to display different versions of the website based on these and other indicators.

In some embodiments, the subject matter may be incorporated in the form of computer-readable storage media including, but not limited to, an electronic, optical, magnetic, or other storage or transmission device capable of providing a processor with computer-readable instructions. Examples of suitable media include, but are not limited to, a floppy disk, CD-ROM, DVD, magnetic disk, memory chip, ROM, RAM, an ASIC, hard disk drive (HDD), solid-state drive (SSD), flash memory, a configured processor, optical media, magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise programming code from any suitable computer-programming language, including but not limited to, for example, C, C++, C#, Visual Basic, Java, Python, Perl, and JavaScript. It will be appreciated that a computer readable storage medium, as used herein, does not include a transitory signal.

While the variable content items have been illustrated herein as constituting advertisements for display in ad slots, such is merely for purposes of illustration and is not limiting. Other formats for the variable content items are contemplated, including web page layouts that omit any and all advertising. In such case, a variable element content server can be used to select appropriate content elements for the associated variable content element slots in the various web page layouts. The variable element content server may operate in a fashion similar to the ad server discussed herein to select an appropriate content element from a pool of available content elements.

From the above description, it is clear that the present disclosure is well adapted to carry out the objectives and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A computer-implemented method comprising:
identifying a plurality of linked web pages of a website of a publisher, each web page having a respective layout comprising associated content and at least one slot adapted to receive a content item;
determining a total number of web pages of the website visited by each device of a plurality of devices during an associated device session in which the device requests display of one or more of the web pages, wherein at least one content item is transferred for display on the device during each said device session; and
identifying a revenue amount to the publisher from said displayed content items for each different total number of web pages visited during said device sessions.

2. The method of claim 1, further comprising modifying the layout of at least one of the web pages of the website in relation to the identified revenue obtained by the publisher and the total accumulated number of web pages in at least one of the device sessions.

3. The method of claim 1, in which the total number of web pages in each device session is determined responsive to the total number of requests for content items received during the device session.

4. The method of claim 1, in which the at least one content item is an advertisement and the at least one content slot is an advertisement slot.

5. The method of claim 1, in which the total accumulated number of web pages is determined by generating a cookie in a server memory responsive to the request to transfer the at least one content item for display of a first web page, and accessing the cookie for each subsequent transfer of a content item for a different one of the web pages visited during the device session.

6. The method of claim 1, in which at least one content item is transferred to each web page visited during each device session.

7. The method of claim 1, in which the at least one content item comprises a click to download item, a click to call item, a click to chat item or a click to purchase item.

8. The method of claim 1, further comprising displaying a table on a graphical user interface that lists total revenue to the publisher for each of a plurality of session lengths having total number of accumulated web pages from 1 to N, where N is a total number of available web pages in the web site having at least one content item slot.

9. The method of claim 1, in which during each device session, the device requests a transfer of a selected web page to the associated network accessible device from a publisher server, and a request for at least one content item is forwarded to a content server responsive to said user request.

10. The method of claim 1, in which the revenue comprises revenue responsive to device selection of at least one displayed content item which connects the network accessible device to a landing page.

11. The method of claim 1, in which the revenue comprises revenue based on a total number of device views of the associated content items displayed on the web pages during the respective device sessions.

12. A computer-readable storage medium which stores associated programming code to:
identify a plurality of linked web pages of a website of a publisher, each web page having a respective layout comprising associated content and at least one slot adapted to receive a content item;
determine a total number of web pages of the website visited by each device of a plurality of devices during an associated device session in which the device requests display of one or more of the web pages, wherein at least one content item is transferred for display on the device during each said device session; and
identify a revenue amount to the publisher from said displayed content items for each different total number of web pages visited during said device sessions.

13. The computer-readable storage medium of claim 12, in which the content item is an advertisement and the content slot is an advertisement slot.

14. An apparatus, comprising:
a content item selection engine adapted to, responsive to receipt of a request for at least one content item to be displayed on a network accessible device in conjunction with display of a web page of a website of a publisher requested by a user of the network accessible device, identify a selected content item from a plurality of available content items in a database in a server memory, and transfer the selected content item to the network accessible device; and
an analysis engine adapted to, responsive to the transfer of the selected content item, initialize a counter value responsive to the transfer of the selected content item, wherein the counter value is incremented responsive to each additional web page of the website visited by the device during a contiguous device session for which at least one additional content item is transferred by the content item selection engine, the analysis engine further adapted to determine a total amount of revenue to the publisher from said displayed content items for each different total accumulated count of web pages during the respective device sessions.

15. The apparatus of claim 14, in which the analysis engine generates a table on a graphical user interface that lists total revenue to the publisher for each of a plurality of session lengths having total number of accumulated web pages from 1 to N, where N is a total number of available web pages in the web site having at least one content item slot.

16. The apparatus of claim 14, in which the total number of web pages in each device session is determined responsive to the total number of requests for content items received during the device session.

17. The apparatus of claim 14, in which the request to transfer an advertisement comprises a request to transfer multiple advertisements to the associated web page, one content item for each content item slot out of a plurality of content item slots on the associated web page.

18. The apparatus of claim 14, in which the at least one content item is a click to download item, a click to call item, a click to chat item or a click to purchase item.

19. The apparatus of claim 14, in which during each device session, the device requests a transfer of a selected web page to the associated network accessible device from a publisher server, and a request for at least one content item is forwarded to a server responsive to said device request.

20. The apparatus of claim 14, in which the revenue comprises revenue responsive to device selection of at least one displayed content item which connects the network accessible device to a landing page.

21. The apparatus of claim 14, in which the revenue comprises revenue based on a total number of device views of the associated content item displayed on the web pages during the respective device sessions.

22. The apparatus of claim 14, in which the respective device sessions comprise first and second device sessions each having a common total number of web page visits, wherein at least one of the web pages in the first device session is not included in the second device session.

23. The apparatus of claim 14, in which the content item selection engine and the analysis engine are realized by programming in server memory executed by a server processor.
